(19) United States
(12) Patent Application Publication
(10) Pub. No.: US 2006/0061110 A1
(43) Pub. Date: Mar. 23, 2006

(54) G-FORCE PUSH-PUSH LATCH

(75) Inventor: Charles A. Haba, Troy, MI (US)

Correspondence Address: JOHN A. ARTZ, ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/711,525

(22) Filed: Sep. 23, 2004

(51) Int. Cl. E05C 19/00

(52) U.S. Cl. 292/300

(57) ABSTRACT

The push-push latch of the present invention is attached to a storage compartment and allows the door of the compartment to move between an open position and a closed position. The latch will remain closed and in a locked position when the door is subjected to a force greater than a predetermined force. The latch includes a track member and a guide member. The track member is molded of a polymer and generally defines a heart shaped track having an integrated retaining section and a channel connecting the heart shaped track and the retaining section. The guide member moves within the heart shaped track to facilitate opening and closing of the compartment door. In the event that the compartment door is subjected to a force greater than a predetermined value while in the closed position, the guide member will be forced through the channel and locked into the retaining section, thereby retaining the door in its closed position.

### TECHNICAL FIELD

The present invention generally relates to a latch system used in association with automotive compartments. The present invention more particularly relates to a push-push latch for use in any compartment in an automobile within the head impact zone.

### BACKGROUND OF THE INVENTION

Push-push latches are being used much more frequently in automotive compartments. There is a large probability that in the event of an accident, the push-push latch will be subjected to a force that opens the compartment and allows the objects within the compartment to exit as projectiles. Therefore, there is a need to retain the latch in a closed position in the event that the latch is subjected to an excessive force.

### SUMMARY OF THE INVENTION

The present invention addresses this need by providing a push-push latch that can be used in association with an automotive compartment where the latch includes a track member that defines a generally heart shaped track having a V-shaped notch and a guide member that moves within the track to facilitate positioning the compartment door in the closed position when the guide member rests in the V-shaped notch. Further, the track member is molded from a polymer and includes an integrated retaining section that is positioned adjacent the V-shaped notch and a channel that connects the heart-shaped track to the retaining section.

### BRIEF DESCRIPTION OF THE DRAWING

The present invention will be described by way of example with reference to the following drawings:

FIG. 1 illustrates a cutaway side view of an automotive compartment with the door in the open position.

FIG. 2 illustrates a cutaway side view of an automotive overhead compartment with the door in the closed position.

FIG. 3 illustrates a sectional view of the track member with the guide member in the opened position.

FIG. 4 illustrates a sectional view of the track member with the guide member in the closed position.

FIG. 5 illustrates a sectional view of the track member locked into the retaining section.

FIG. 6 is a flowchart illustrating the preferred method of this invention.

### DETAILED DESCRIPTION OF THE PREFERRED EMBODIMENT

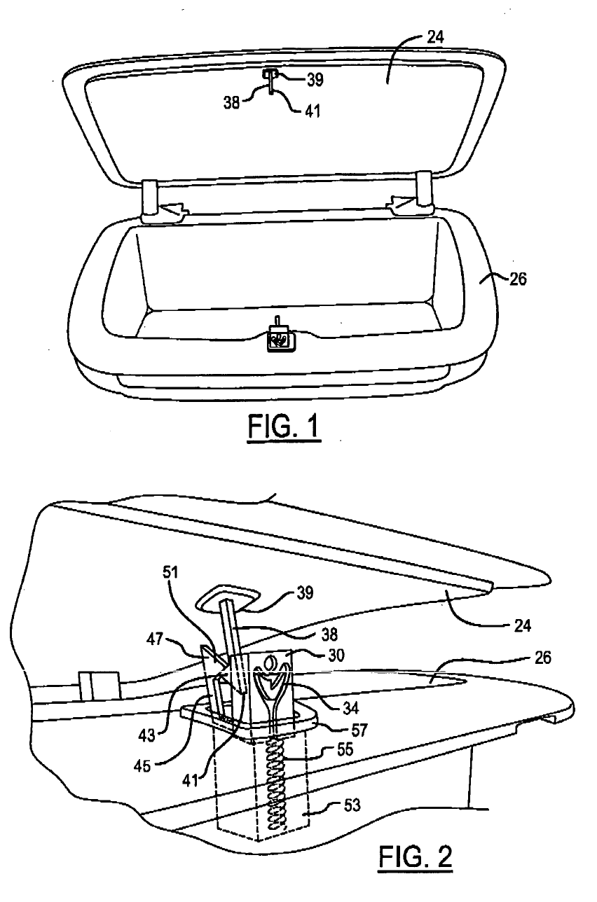

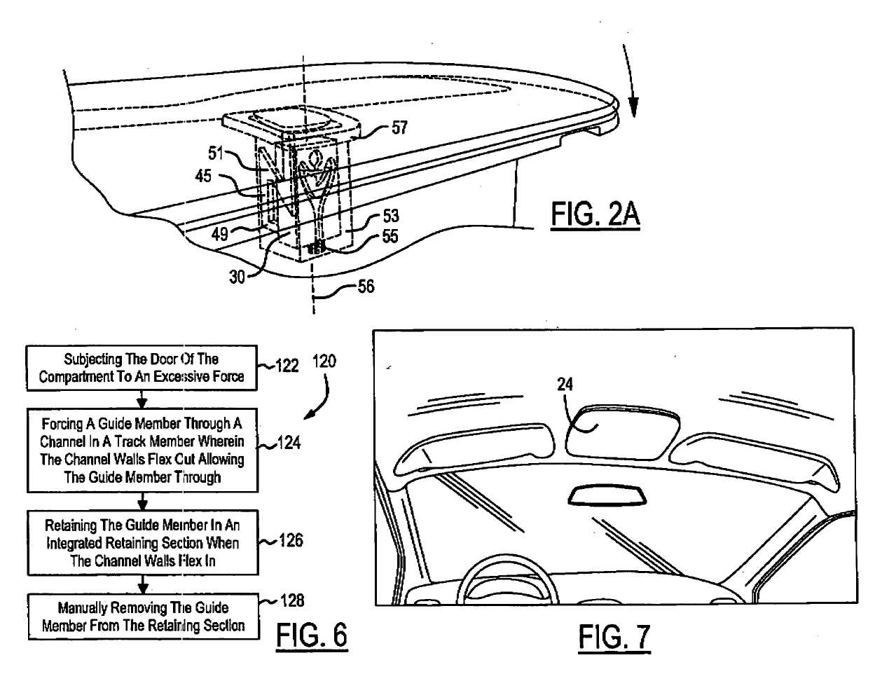

The push-push latch of the present invention, shown generally at 20 in FIGS. 1-5, is used in association with a storage compartment 22 in an automobile to facilitate moving the compartment door 24 between an opened position, as illustrated in FIG. 1, and a closed position, as illustrated in FIG. 2. It should be noted that the push-push latch of the present invention is not limited to automotive compartments, rather, it can be used in association with any compartment or environment that requires a latch.

When the door 24 is in the open position it is pushed by a user inwardly toward the compartment body 26 and engaged in the closed position. To open the door 24 from the closed position, the door 24 is again pushed inwardly toward the compartment body 26 and the latch 20 is disengaged, thus releasing the door 24 into the open position. In the event that the compartment door 24 is closed and subjected to a force that exceeds a predetermined value, the door 24 will become locked in the closed position.

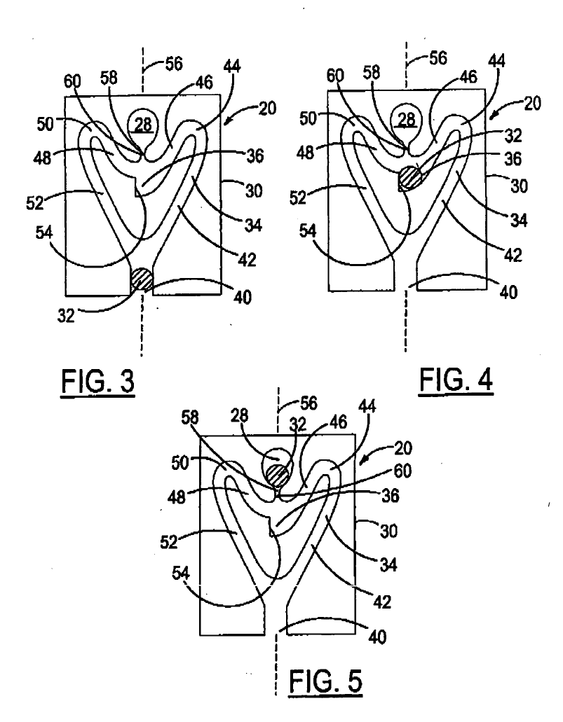

Referring to FIG. 3, the push-push latch 20 includes a track member 30 and a guide member 32. The track member 30 is molded from a polymer and defines a generally heart shaped track 34 having a V-shaped notch 36. The guide member 32 moves within the track 34 to facilitate positioning the compartment door 24 between the closed position and the opened position.

There is a connector 38, shown in FIG. 1, that is permanently attached to the compartment door 24 and that engages the push-push latch 20. In other words, neither the track member 30 nor the guide member 32 is permanently attached to the compartment door 24. Rather, the connector 38 engages either the track member 30 or the guide member 32 depending on the configuration of the system.

The heart-shaped track 34 includes pathway A also referred to as first pathway 40, pathway B also referred to as second pathway 42, first corner 44, pathway C also referred to as third pathway 46, the V-shaped notch 36, pathway D also referred to as fourth pathway 48, second corner 50, and pathway E also referred to as fifth pathway 52. The V-shaped notch 36 includes a wall 54 that assists in retaining guide member 32 in the closed position.

It is important to note that track member 30 has the ability to move axially along axis 56 and that guide member 32 has the ability to move radially with respect to axis 56.

Referring to FIG. 3, under normal circumstances when the door 24 of the compartment 22 is in the opened position the guide member 32 is resting in pathway A 40. When a force is exerted on the door 24 to push it into the closed position, the connector 38 on the compartment door 24 engages the push-push latch 20. This engagement forces guide member 32 to move from pathway A 40 into pathway B 42 and travel along the length of pathway B 42, and around the first corner 44 into pathway C 46. Guide member 32 moves along the length of pathway C 46 and comes to a rest at the V-shaped notch 36. Therefore, when in the closed position the guide member 32 is positioned in the V-shaped notch 36 of the track member 30 resting against wall 54.

When a force is exerted on the compartment door 24 in an effort to move the door 24 from the closed position to the opened position, under normal circumstances, guide member 32 is forced out from V-shaped notch 36 and into pathway D 48. After traveling the length of pathway D 48 guide member 32 moves around the second corner 50 and travels down the length of pathway E 52. Pathway E 52 merges into pathway A 40 and guide member 32 comes to a rest back in pathway A 40. The connector 38 disengages from the push-push latch 20 once guide member 32 is positioned within pathway A 40 causing the compartment door 24 to move into the opened position.

The majority of the time the compartment door 24 is going to be in the closed position. A user typically will open the door 24 only to put an object into the compartment 22 or to remove an object from the compartment 22 and immediately return the door 24 to the closed position. Therefore, the guide member 32 rests in the V-shaped notch 36 of the track member 30 the majority of the time.

In the event of an automobile collision, there is a chance that the compartment door 24 will be subjected to an excessive force. Therefore, it is desired to keep the door 24 locked in its closed position under such circumstances, rather than being allowed to open thereby subjecting the vehicle occupant to an open door member or exposing them to the objects contained within the storage compartment 22. To address this situation, the present invention provides for a track member 30 that is molded from a polymer and includes an integrated retaining section 28 that is

1. A push-push latch attached to a storage compartment having a door that moves between an opened position and a closed position, said push-push latch comprising:
a track member defining a generally heart shaped track having a generally V-shaped notch;
a guide member that moves within said track to facilitate positioning said compartment door in the closed position when said guide member rests in the V-shaped notch;
wherein said track member is molded from a polymer and includes an integrated enclosed retaining section adjacent said V-shaped notch and a double wall charnel connecting said V-shaped notch and said enclosed retaining section, wherein said channel has a width dimension less than the width dimension of said guide member; and
wherein when the compartment door is in the closed position and the guide member is positioned in the V-shaped notch and when subjected to a force greater than a predetermined value said guide member is forced directly from said V-shaped notch through said channel and locked into said retaining section locking said compartment door in the closed position.

2. The push-push latch of claim 1, wherein said walls of said channel flex out when said guide member is subjected to a force greater than a predetermined force value allowing said guide member through to said retaining section.

3. The push-push latch of claim 1 further comprising a connector attached to the compartment door.

4. (canceled)

5. (canceled)

6. The push-push latch of claim 1, wherein said heart shaped track further includes a pathway A, a pathway B, a first corner, a pathway C, a pathway D, a second corner, and a pathway E, wherein said pathway A is adjacent said pathway B and said pathway E, said pathway B is adjacent said first corner, said first corner is adjacent said pathway C, said pathway C is adjacent said V-shaped notch, said V-shaped notch is adjacent said pathway D, said pathway D is adjacent said second corner, and said second corner is adjacent pathway E.

7. The push-push latch of claim 6 wherein when the compartment door is in the opened position, said guide member is positioned in said pathway A.

8. The push-push latch of claim 6 wherein when the compartment door is moving from the opened position into the closed position, said guide member travels from said pathway A into and along the length of said pathway B, around said first corner, into and along the length of said pathway C, and coming to a rest in said V-shaped notch.

9. The push-push latch of claim 6 wherein when the compartment door is moving from the closed position into the opened position, said guide member travels from said V-shaped notch, into and along the length of said pathway D, around said second corner, into and along the length of said pathway E, and into said pathway A.

10. The push-push latch of claim 6 wherein when the compartment door is in the dosed position and subjected to a force greater than a predetermined value, said guide member moves from said V-shaped notch into said channel forcing said walls to flex out and said guide member comes to a rest in said re ting section.

11. The push-push latch of claim 1, wherein said V-shaped notch includes a wall that assists in retaining said guide member in the closed position.

12. The push-push latch of claim 1, wherein said track member defines an axis and said guide member moves radially with respect to the axis to travel within said heart-shaped track.

13. The push-push latch of claim 1, wherein said storage compartment is in an automobile.

14. The push-push latch of claim 1, wherein said heart shaped track further includes a first pathway, a second pathway, a first corner, a third pathway, a fourth pathway, a second corner, and a fifth pathway, wherein said first pathway is adjacent said second pathway and said fifth pathway, said second pathway is adjacent said first corner, said first corner is adjacent said third pathway, said third pathway is adjacent said V-shaped notch, said V-shaped notch is adjacent said fourth pathway, said fourth pathway is adjacent said second corner, and said second corner is adjacent said fifth pathway.

15. A storage compartment comprising:
a compartment body;
a compartment door that is attached to said compartment body and moves between a closed position and an opened position;
a push-push latch that is attached to said compartment body and engages said compartment door, said push-push latch having a track member defining a generally heart shaped track having a generally V-shaped notch, a guide member that moves within said track to facilitate positioning said compartment door in the closed position when said guide member rests in the V-shaped notch, wherein said track member is molded from a polymer and includes an integrated bounded retaining section adjacent said V-shaped notch and a two wall channel connecting said V-shaped notch and said retaining section, said channel has a width dimension that is less Fan a width dimension of said heart shaped track; and
wherein when the compartment door is in the closed position and the guide member is positioned in the V-shaped notch and when subjected to a force greater than a predetermined value said guide member is forced directly from said V-shaped notch through said channel causing said walls to flex out and locked into said retaining section when said walls flex back in.

16. (canceled)

17. The storage compartment of claim 15 wherein said track member defines an axis and said guide member moves radially with respect to the axis to travel within said heart-shaped track.

18. The storage compartment of claim 15 wherein said heart shaped track further includes a first pathway, a second pathway, a first corner, a third pathway, a fourth pathway, a second corner, and a fifth pathway, wherein said first pathway is adjacent said second pathway and said fifth pathway, said second pathway is adjacent said first corner, said first corner is adjacent said third pathway, said third pathway is adjacent said V-shaped notch, said V-shaped notch is adjacent said fourth pathway, said fourth pathway is adjacent said second corner, and said second corner is adjacent said fifth pathway.

19. A method of locking a compartment door in a closed position when subjected to an excessive force, wherein the compartment door moves between an opened and a closed position via a push-push latch made from a polymer and having a track member and a guide member, comprising the steps of:
A) subjecting the door of the compartment to an excessive force;
B) causing a guide member to move through a channel in a track member wherein the channel walls flex out allowing the guide member through; and
C) retaining the guide member in an integrated bounded retaining section when the channel walls flex in.

20. The method of claim 19 further comprising manually removing the guide member from the retaining section.

21. The push-push latch of claim 3 wherein said track member includes a clamp member having a first end and a second end, said first end includes a protrusion and said second end is pivotally attached to said track member.

22. The push-push latch of claim 21 wherein said connector includes a first end and a second end; said first end is attached to the compartment door and said second end includes a protrusion that matingly engages with said clamp member protrusion to secure the compartment door in the closed position.

23. The push-push latch of claim 22 wherein the storage compartment includes a recess for receipt of said track member and said track member is spring loaded within the recess.

24. (canceled)
